(19) United States
(12) Patent Application Publication
(10) Pub. No.: US 2021/0291623 A1
(43) Pub. Date: Sep. 23, 2021

(54) PRE-CONDITIONING CLIMATE CONTROL BASED ON USER'S CALENDAR AND DAILY ROUTINE

(71) Applicant: NIO USA, Inc., San Jose, CA (US)

(72) Inventors: Anqi Wang, San Jose, CA (US); An Wu, San Jose, CA (US); Matthew J. Daigle, Sunnyvale, CA (US); Sama Aghniaey, San Jose, CA (US); Bruno M. Barthelemy, Los Gatos, CA (US)

(21) Appl. No.: 16/822,435

(22) Filed: Mar. 18, 2020

(51) Int. Cl. B60H 1/00

(52) U.S. Cl. CPC B60H 1/00971; B60H 1/0073; B60H 1/00771

(57) ABSTRACT

Embodiments include a method for pre-conditioning a cabin of a vehicle, the method comprising: collecting, by a climate control system of the vehicle, a set of current conditions related to the vehicle; sending, by the climate control system of the vehicle, to a cloud-based climate control service, the collected set of current conditions related to the vehicle; receiving, by the climate control system of the vehicle from the cloud-based climate control service, a set of pre-conditioning instructions defining operation of the climate control system of the vehicle without input from a user of the vehicle and before the user enters the vehicle; and controlling, by the climate control system of the vehicle, a Heating, Ventilating, and Air Conditioning (HVAC) system of the vehicle based on the received pre-conditioning instructions.

### FIELD

The present disclosure is generally directed to vehicle climate control systems and in particular toward pre-conditioning of a vehicle's cabin by a climate control system based on a user's calendar and/or daily routine, current conditions, and other factors.

### BACKGROUND

Currently, a Heating Ventilating and Air Conditioning (HVAC) system of a vehicle can be controlled to pre-condition a cabin of the vehicle. In current systems, a user can use an app installed on and executed by a smart phone or other device to turn the HVAC system ON/OFF and, in some cases, change HVAC settings remotely, without getting into the vehicle. However, such current approaches require manual input by the user. Additionally, these approaches to pre-condition the vehicle cabin are not considering numerous factors that influence cabin comfort such as traffic conditions, real-time vehicle cabin temperature, ambient temperature, etc. Hence, there is a need in the art for improved methods and systems for vehicle climate control.

### BRIEF DESCRIPTION OF THE DRAWINGS

FIG. 1 illustrates a view of a vehicle in which embodiments of the present disclosure may be implemented.

FIG. 2 is a block diagram illustrating elements of an exemplary climate control system for a vehicle according to one embodiment of the present disclosure.

FIG. 3 is a block diagram illustrating additional details of a vehicle climate control module according to one embodiment of the present disclosure.

FIG. 4 is a block diagram illustrating additional details of a cloud-based climate control service according to one embodiment of the present disclosure.

FIG. 5 is a flowchart illustrating an exemplary process for climate control in a vehicle according to one embodiment of the present disclosure.

FIG. 6 is a flowchart illustrating an exemplary process for climate control by a cloud-based climate control service according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

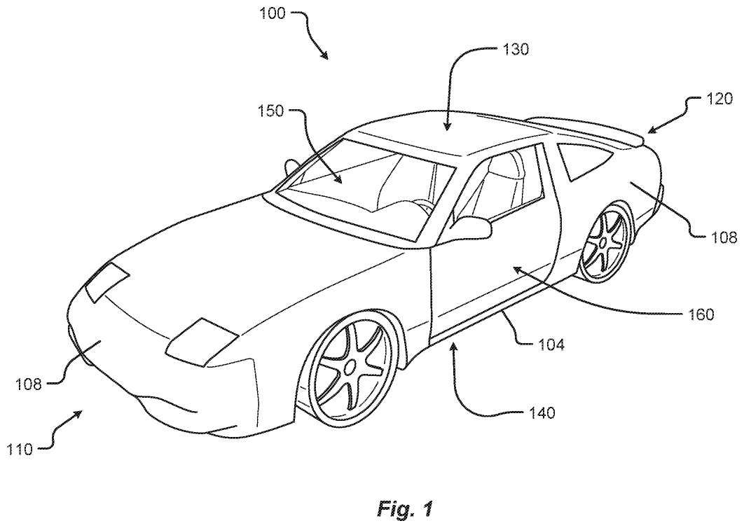

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

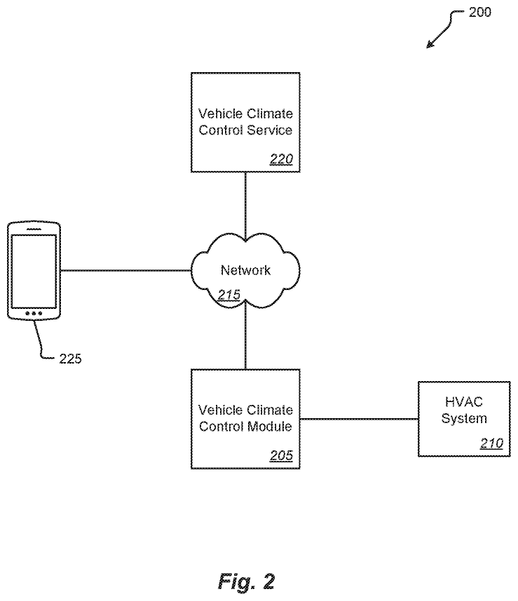

FIG. 2 is a block diagram illustrating elements of an exemplary climate control system for a vehicle according to one embodiment of the present disclosure. As illustrated in this example, a system 200 for climate control in a vehicle 100 can comprise a climate control module 205 and Heating, Ventilation, and Air Conditioning (HVAC) system 210 within the vehicle 100. The climate control module 205 can be communicatively coupled with a wireless communications network 215 such as a cellular or other wireless network. Also coupled with the network 215 can be a climate control service 220 implemented on one or more web servers or other servers as known in the art. Generally speaking, vehicle climate control according to embodiments described herein can comprise synchronizing a vehicle user's calendar information and studying the user's daily routine. Based on real-time ambient thermal condition, cabin thermal condition, traffic condition and time to travel to destination, the HVAC system 210, seats, etc. can be conditioned before the user gets into the vehicle 100. Generally speaking, pre-conditioning of the cabin of the vehicle 100 can comprise retrieving the user's calendar information and/or daily activities, e.g., from the user's phone, personal information manager application, etc. Vehicle cabin temperature, ambient temperature, location and status information can also be retrieved from the vehicle 100 itself. Travel time and pre-condition time can be calculated by the cloud-based climate control service 220 based on current traffic condition and temperature, e.g., retrieved from third party providers as known in the art. A notification of the pre-conditioning can be sent from the cloud-based climate control service 220 to a device 225 of the user of the vehicle, e.g., the user's cell phone, tablet, smart watch, personal computer, etc. In response to the user accepting the pre-conditioning, the cloud-based climate control service 220 can then send the pre-conditioning instructions to the climate control system 205 of the vehicle for controlling the HVAC system 210.

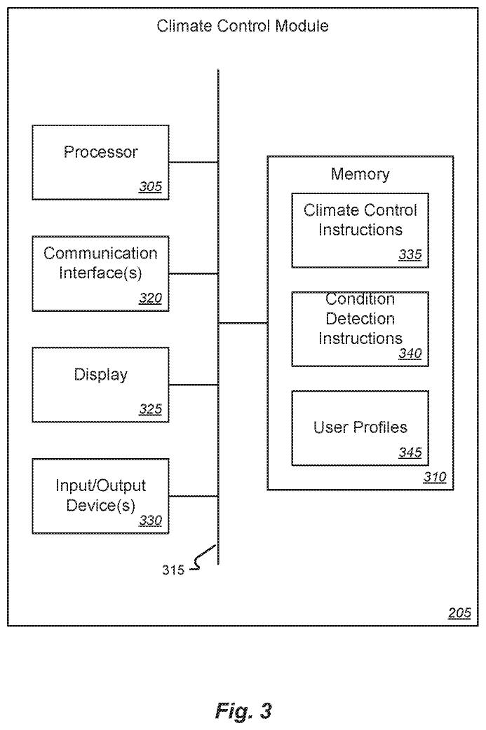

FIG. 3 is a block diagram illustrating additional details of a vehicle climate control module according to one embodiment of the present disclosure. As illustrated in this example, a climate control module 205 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the climate control module 205 as described herein.

A memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 and a display 325 via the communications bus 315. The communication interfaces 320 can comprise, for example, a Bluetooth, WiFi, or other type of wireless communications interface, for example for communicating with wearable and/or mobile devices of the users within the vehicle. In some cases, the communication interfaces 320 can also include an interface for communicating via a wireless network. The display 325 can comprise, for example, a Liquid Crystal Display (LCD), Light Emitting Diode (LED), Organic Light Emitting Diode (OLED), Plasma Display Panel (PDP), Cathode Ray Tube (CRT) display or other type of display for presenting a climate control user interface. Any number of input/output devices 330, including, but not limited to, the ambient temperature sensors etc. can also be coupled with the communications bus 315.

The memory 310 can store therein sets of instructions which, when executed by the processor 305, cause the processor 305 to control an HVAC system 210 of a vehicle 100 as described herein. More specifically, the memory 310 can store a set of condition detection instructions 340 which can, when executed by the processor 305, cause the processor 305 to collect a set of current conditions related to the vehicle. For example, the set of current conditions related to the vehicle can include, but is not limited to, a current cabin temperature, a current ambient temperature, a location, etc. The detection instruction instructions can further cause the processor to send the collected set of current conditions related to the vehicle to a cloud-based climate control service. In response, a set of pre-conditioning instructions can be received from the cloud-based climate control service. The pre-conditioning instructions can define operation of the climate control system of the vehicle without input from a user of the vehicle and before the user enters the vehicle and can be determined by the cloud-based climate control service based on the set of current conditions related to the vehicle. In some cases, the pre-conditioning instructions can be further determined by the cloud-based climate control service based on user calendar information, a learned user routine, current weather information for a location of the vehicle, current traffic information for a predicted route of the vehicle, e.g., based on the scheduling information for the user of the vehicle, etc. A set of climate control instructions 335, when executed by the processor, can then cause the processor to control the HVAC system 210 of the vehicle 100 based on the received pre-conditioning instructions.

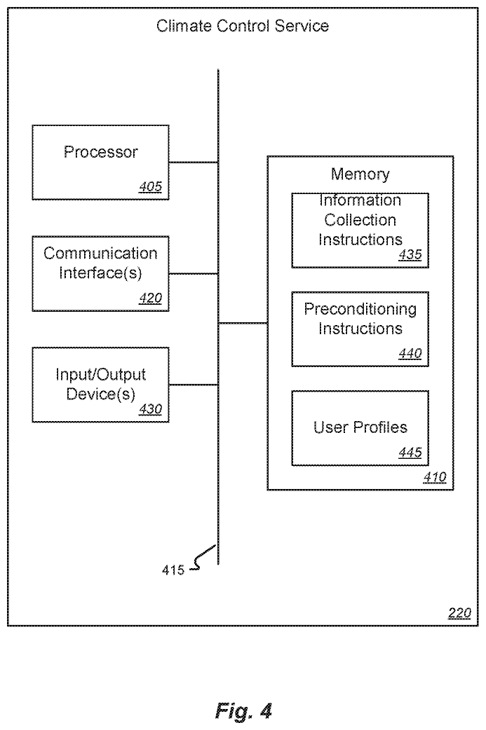

FIG. 4 is a block diagram illustrating additional details of a cloud-based climate control service according to one embodiment of the present disclosure. As illustrated in this example, a cloud-based climate control service 220 can comprise a processor 405 such as any of the processors described above. The processor 405 can be coupled with a memory 410 such as any of the volatile or non-volatile memories also described above via a communications bus 415 as also described. The processor 405 can also be connected with one or more communications interfaces 420 such as any wired and/or wireless communications interfaces as known in the art and one or more input/output devices 430 such as a keyboard, mouse, display, printer or other devices as known in the art.

The memory 410 can store therein instruction including a set of information collection instructions 435 which, when executed by the processor 405, can cause the processor 405 to collect a set of schedule information for a user of the vehicle. The schedule information can indicate a future use of the vehicle. For example, the set of schedule information for the user of the vehicle can comprise a set of calendar information collected by the cloud-based climate control service, e.g., from a calendar application on the user's mobile device, a personal information manager application, etc. Additionally, or alternatively, the set of schedule information for the user of the vehicle can comprise information based on a learned routine of the user of the vehicle and maintained by the cloud-based climate control service.

The information collection instructions can also cause the processor 405 to collect a set of information defining current conditions related to the vehicle. For example, the set of information defining current conditions related to the vehicle can comprise information received by the cloud-based climate control service from the vehicle and defining a current cabin temperature, a current ambient temperature, and a location of the vehicle. Additionally, or alternatively, the set of information defining current conditions related to the vehicle can comprise information collected by the cloud-based climate control service from a third-party weather reporting service and defining weather conditions at a location of the vehicle. The set of information defining current conditions related to the vehicle can additionally or alternatively comprise information collected by the cloud-based climate control service from a third-party traffic reporting service and defining traffic conditions along an expected route of the vehicle based on the set of scheduling information for the user of the vehicle.

The memory 410 can also store therein a set of climate control instructions which, when executed by the processor 405, cause the processor 405 to calculate a set of pre-conditioning instructions based on the collected set of schedule information for the user of the vehicle and the collected set of current conditions related to the vehicle. The set of pre-conditioning instructions can define operation of a climate control system of the vehicle. In some cases, the climate control instructions 440 can cause the processor 405 to send a notification of the calculated pre-conditioning instructions to a device of the user of the vehicle and receive a response to the notification from the device of the user. The climate control instructions 440 can cause the processor 405 to make a determination as to whether the user has accepted the pre-conditioning instructions. In response to determining the user has accepted the pre-conditioning instructions, the calculated set of pre-conditioning instructions can be sent to the vehicle. The climate control system of the vehicle can then control the HVAC system based on the set of pre-conditioning instructions without input from the user of the vehicle and before the user enters the vehicle.

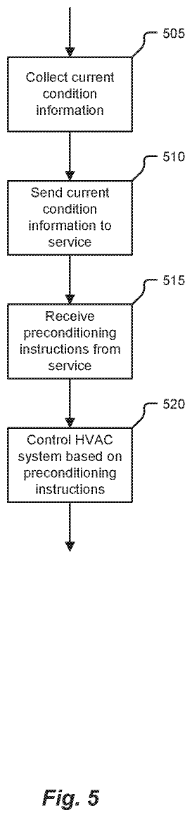

FIG. 5 is a flowchart illustrating an exemplary process for climate control in a vehicle according to one embodiment of the present disclosure. As illustrated in this example, pre-conditioning a cabin of a vehicle can comprise collecting 505 a set of current conditions related to the vehicle. For example, the set of current conditions related to the vehicle can include, but is not limited to, a current cabin temperature, a current ambient temperature, a location, etc. The collected set of current conditions related to the vehicle can be sent 510 to a cloud-based climate control service. In response, a set of pre-conditioning instructions can be received 515 from the cloud-based climate control service. The pre-conditioning instructions can define operation of the climate control system of the vehicle without input from a user of the vehicle and before the user enters the vehicle and can be determined by the cloud-based climate control service based on the set of current conditions related to the vehicle. In some cases, the pre-conditioning instructions can be further determined by the cloud-based climate control service based on user calendar information, a learned user routine, current weather information for a location of the vehicle, current traffic information for a predicted route of the vehicle, e.g., based on the scheduling information for the user of the vehicle, etc. The HVAC system 210 of the vehicle 100 can then be controlled 520 based on the received pre-conditioning instructions.

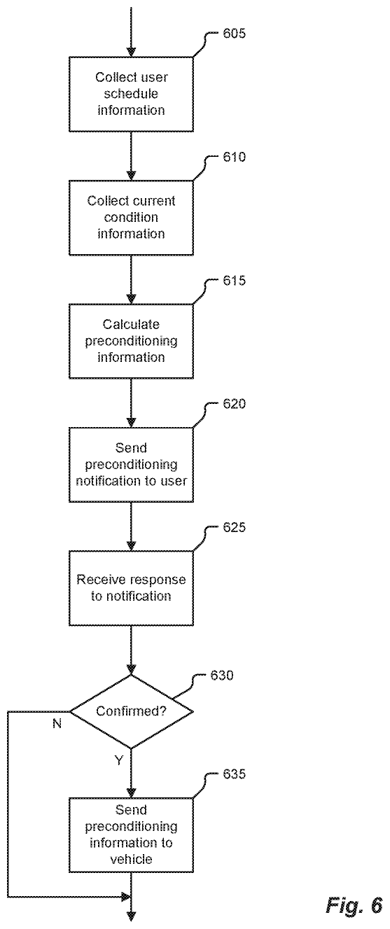

FIG. 6 is a flowchart illustrating an exemplary process for climate control by a cloud-based climate control service according to one embodiment of the present disclosure. As illustrated in this example, pre-conditioning a cabin of a vehicle can comprise collecting 605 a set of schedule information for a user of the vehicle. The schedule information can indicate a future use of the vehicle. For example, the set of schedule information for the user of the vehicle can comprise a set of calendar information collected by the cloud-based climate control service. Additionally, or alternatively, the set of schedule information for the user of the vehicle can comprise information based on a learned routine of the user of the vehicle and maintained by the cloud-based climate control service.

A set of information defining current conditions related to the vehicle can also be collected 610. For example, the set of information defining current conditions related to the vehicle can comprise information received by the cloud-based climate control service from the vehicle and defining a current cabin temperature, a current ambient temperature, and a location of the vehicle. Additionally, or alternatively, the set of information defining current conditions related to the vehicle can comprise information collected by the cloud-based climate control service from a third-party weather reporting service and defining weather conditions at a location of the vehicle. The set of information defining current conditions related to the vehicle can additionally or alternatively comprise information collected by the cloud-based climate control service from a third-party traffic reporting service and defining traffic conditions along an expected route of the vehicle based on the set of scheduling information for the user of the vehicle.

A set of pre-conditioning instructions can be calculated 615 based on the collected set of schedule information for the user of the vehicle and the collected set of current conditions related to the vehicle. The set of pre-conditioning instructions can define operation of a climate control system of the vehicle. In some cases, a notification of the calculated pre-conditioning instructions can be sent 620 to a device of the user of the vehicle and a response to the notification can be received 625 from the device of the user. A determination 630 can be made as to whether the user has accepted the pre-conditioning instructions. In response to determining 630 the user has accepted the pre-conditioning instructions; the calculated set of pre-conditioning instructions can be sent 635 to the vehicle. The climate control system of the vehicle can then control the HVAC system based on the set of pre-conditioning instructions without input from the user of the vehicle and before the user enters the vehicle.

Embodiments include a method for pre-conditioning a cabin of a vehicle, the method comprising: collecting, by a climate control system of the vehicle, a set of current conditions related to the vehicle; sending, by the climate control system of the vehicle, to a cloud-based climate control service, the collected set of current conditions related to the vehicle; receiving, by the climate control system of the vehicle from the cloud-based climate control service, a set of pre-conditioning instructions defining operation of the climate control system of the vehicle without input from a user of the vehicle and before the user enters the vehicle; and controlling, by the climate control system of the vehicle, a Heating, Ventilating, and Air Conditioning (HVAC) system of the vehicle based on the received pre-conditioning instructions.

Aspects of the above method include wherein the set of current conditions related to the vehicle comprises a current cabin temperature, a current ambient temperature, and a location.

Aspects of the above method include wherein the pre-conditioning instructions are determined by the cloud-based climate control service based on the set of current conditions related to the vehicle.

Aspects of the above method include wherein the pre-conditioning instructions are further determined by the cloud-based climate control service based on user calendar information.

Aspects of the above method include wherein the pre-conditioning instructions are further determined by the cloud-based climate control service based on a learned user routine.

Aspects of the above method include wherein the pre-conditioning instructions are further determined by the cloud-based climate control service based on current weather information for a location of the vehicle.

Aspects of the above method include wherein the pre-conditioning instructions are further determined by the cloud-based climate control service based on current traffic information for a predicted route of the vehicle.

Embodiments include a method for pre-conditioning a cabin of a vehicle, the method comprising: collecting, by a cloud-based climate control service, a set of schedule information for a user of the vehicle, the schedule information indicating a future use of the vehicle; collecting, by the cloud-based climate control service, a set of information defining current conditions related to the vehicle; calculating, by the cloud-based climate control service, a set of pre-conditioning instructions based on the collected set of schedule information for the user of the vehicle and the collected set of current conditions related to the vehicle, the set of pre-conditioning instructions defining operation of a climate control system of the vehicle; and sending, by the cloud-based climate control service, to the vehicle, the calculated set of pre-conditioning instructions, wherein a climate control system of the vehicle controls a Heating, Ventilating, and Air Conditioning (HVAC) system based on the set of pre-conditioning instructions without input from the user of the vehicle and before the user enters the vehicle.

Aspects of the above method further include sending, by the cloud-based climate control service, a notification of the calculated pre-conditioning instructions to a device of the user of the vehicle; and receiving, by the cloud-based climate control service, a response to the notification from the device of the user, wherein sending the calculated set of pre-conditioning instructions to the vehicle is performed in response to the response indicating acceptance of the pre-conditioning instructions by the user of the vehicle.

Aspects of the above method include wherein the set of schedule information for the user of the vehicle comprises a set of calendar information collected by the cloud-based climate control service.

Aspects of the above method include wherein the set of schedule information for the user of the vehicle comprises information based on a learned routine of the user of the vehicle and maintained by the cloud-based climate control service.

Aspects of the above method include wherein the set of information defining current conditions related to the vehicle comprises information received by the cloud-based climate control service from the vehicle and defining a current cabin temperature, a current ambient temperature, and a location of the vehicle.

Aspects of the above method include wherein the set of information defining current conditions related to the vehicle comprises information collected by the cloud-based climate control service from a third-party weather reporting service and defining weather conditions at a location of the vehicle.

Aspects of the above method include wherein the set of information defining current conditions related to the vehicle comprises information collected by the cloud-based climate control service from a third-party traffic reporting service and defining traffic conditions along an expected route of the vehicle based on the set of scheduling information for the user of the vehicle.

Embodiments include system comprising: a wireless communications network; a vehicle communicatively coupled with the wireless communications network, the vehicle comprising a Heating, Ventilation, and Air Conditioning (HVAC) system and a climate control system controlling the HVAC system, the climate control system comprising a processor and a memory coupled with and readable by the processor and storing therein a set of instructions which, when executed by the processor, causes the processor to pre-condition a cabin of the vehicle by: collecting a set of current conditions related to the vehicle, and sending the collected set of current conditions related to the vehicle over the wireless communications network; a server of a cloud-based climate control service communicatively coupled with the wireless communications network, the server of the cloud-based climate control service comprising a processor and a memory coupled with and readable by the process and storing therein a set of instructions which, when executed by the processor, causes the processor to pre-condition the cabin of the vehicle by: collecting a set of schedule information for a user of the vehicle, the schedule information indicating a future use of the vehicle; receiving, from the vehicle, the set of information defining current conditions related to the vehicle; calculating a set of pre-conditioning instructions based on the collected set of schedule information for the user of the vehicle and the received set of current conditions related to the vehicle, the set of pre-conditioning instructions defining operation of the climate control system of the vehicle; and sending, to the vehicle, the calculated set of pre-conditioning instructions.

Aspects of the above system include wherein the instructions stored in the memory of the climate control system of the vehicle further cause the processor of the climate control system of the vehicle to: receive the set of pre-conditioning instructions from the cloud-based climate control service; and control the HVAC system of the vehicle based on the received pre-conditioning instructions.

Aspects of the above system include wherein the instructions stored in the memory of the server of the cloud-based climate control service further cause the processor to: send a notification of the calculated pre-conditioning instructions to a device of the user of the vehicle; and receive a response to the notification from the device of the user, wherein sending the calculated set of pre-conditioning instructions to the vehicle is performed in response to the response indicating acceptance of the pre-conditioning instructions by the user of the vehicle.

Aspects of the above system include wherein the set of schedule information for the user of the vehicle comprises at least one of a set of calendar information collected by the cloud-based climate control service or information based on a learned routine of the user of the vehicle and maintained by the cloud-based climate control service.

Aspects of the above system include wherein the set of information defining current conditions related to the vehicle comprises information received by the cloud-based climate control service from the vehicle and defining a current cabin temperature, a current ambient temperature, and a location of the vehicle.

Aspects of the above system include wherein the set of information defining current conditions related to the vehicle comprises at least one of information collected by the cloud-based climate control service from a third-party weather reporting service and defining weather conditions at a location of the vehicle or information collected by the cloud-based climate control service from a third-party traffic reporting service and defining traffic conditions along an expected route of the vehicle based on the set of scheduling information for the user of the vehicle.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method for pre-conditioning a cabin of a vehicle, the method comprising:
collecting, by a climate control system of the vehicle, a set of current conditions related to the vehicle;
sending, by the climate control system of the vehicle, to a cloud-based climate control service, the collected set of current conditions related to the vehicle;
receiving, by the climate control system of the vehicle from the cloud-based climate control service, a set of pre-conditioning instructions defining operation of the climate control system of the vehicle without input from a user of the vehicle and before the user enters the vehicle; and
controlling, by the climate control system of the vehicle, a Heating, Ventilating, and Air Conditioning (HVAC) system of the vehicle based on the received pre-conditioning instructions.

2. The method of claim 1, wherein the set of current conditions related to the vehicle comprises a current cabin temperature, a current ambient temperature, and a location.

3. The method of claim 2, wherein the pre-conditioning instructions are determined by the cloud-based climate control service based on the set of current conditions related to the vehicle.

4. The method of claim 3, wherein the pre-conditioning instructions are further determined by the cloud-based climate control service based on user calendar information.

5. The method of claim 4, wherein the pre-conditioning instructions are further determined by the cloud-based climate control service based on a learned user routine.

6. The method of claim 4, wherein the pre-conditioning instructions are further determined by the cloud-based climate control service based on current weather information for a location of the vehicle.

7. The method of claim 4, wherein the pre-conditioning instructions are further determined by the cloud-based climate control service based on current traffic information for a predicted route of the vehicle.

8. A method for pre-conditioning a cabin of a vehicle, the method comprising:
collecting, by a cloud-based climate control service, a set of schedule information for a user of the vehicle, the schedule information indicating a future use of the vehicle;
collecting, by the cloud-based climate control service, a set of information defining current conditions related to the vehicle;
calculating, by the cloud-based climate control service, a set of pre-conditioning instructions based on the collected set of schedule information for the user of the vehicle and the collected set of current conditions related to the vehicle, the set of pre-conditioning instructions defining operation of a climate control system of the vehicle; and
sending, by the cloud-based climate control service, to the vehicle, the calculated set of pre-conditioning instructions, wherein a climate control system of the vehicle controls a Heating, Ventilating, and Air Conditioning (HVAC) system based on the set of pre-conditioning instructions without input from the user of the vehicle and before the user enters the vehicle.

9. The method of claim 8, further comprising:
sending, by the cloud-based climate control service, a notification of the calculated pre-conditioning instructions to a device of the user of the vehicle; and
receiving, by the cloud-based climate control service, a response to the notification from the device of the user, wherein sending the calculated set of pre-conditioning instructions to the vehicle is performed in response to the response indicating acceptance of the pre-conditioning instructions by the user of the vehicle.

10. The method of claim 8, wherein the set of schedule information for the user of the vehicle comprises a set of calendar information collected by the cloud-based climate control service.

11. The method of claim 8, wherein the set of schedule information for the user of the vehicle comprises information based on a learned routine of the user of the vehicle and maintained by the cloud-based climate control service.

12. The method of claim 8, wherein the set of information defining current conditions related to the vehicle comprises information received by the cloud-based climate control service from the vehicle and defining a current cabin temperature, a current ambient temperature, and a location of the vehicle.

13. The method of claim 8, wherein the set of information defining current conditions related to the vehicle comprises information collected by the cloud-based climate control service from a third-party weather reporting service and defining weather conditions at a location of the vehicle.

14. The method of claim 8, wherein the set of information defining current conditions related to the vehicle comprises information collected by the cloud-based climate control service from a third-party traffic reporting service and defining traffic conditions along an expected route of the vehicle based on the set of scheduling information for the user of the vehicle.

15. A system comprising:
a wireless communications network;
a vehicle communicatively coupled with the wireless communications network, the vehicle comprising a Heating, Ventilation, and Air Conditioning (HVAC) system and a climate control system controlling the HVAC system, the climate control system comprising a processor and a memory coupled with and readable by the processor and storing therein a set of instructions which, when executed by the processor, causes the processor to pre-condition a cabin of the vehicle by:
collecting a set of current conditions related to the vehicle, and
sending the collected set of current conditions related to the vehicle over the wireless communications network;
a server of a cloud-based climate control service communicatively coupled with the wireless communications network, the server of the cloud-based climate control service comprising a processor and a memory coupled with and readable by the process and storing therein a set of instructions which, when executed by the processor, causes the processor to pre-condition the cabin of the vehicle by:
collecting a set of schedule information for a user of the vehicle, the schedule information indicating a future use of the vehicle;
receiving, from the vehicle, the set of information defining current conditions related to the vehicle;
calculating a set of pre-conditioning instructions based on the collected set of schedule information for the user of the vehicle and the received set of current conditions related to the vehicle, the set of pre-conditioning instructions defining operation of the climate control system of the vehicle; and
sending, to the vehicle, the calculated set of pre-conditioning instructions.

16. The system of claim 15, wherein the instructions stored in the memory of the climate control system of the vehicle further cause the processor of the climate control system of the vehicle to:
receive the set of pre-conditioning instructions from the cloud-based climate control service; and
control the HVAC system of the vehicle based on the received pre-conditioning instructions.

17. The system of claim 15, wherein the instructions stored in the memory of the server of the cloud-based climate control service further cause the processor to:
send a notification of the calculated pre-conditioning instructions to a device of the user of the vehicle; and
receive a response to the notification from the device of the user, wherein sending the calculated set of pre-conditioning instructions to the vehicle is performed in response to the response indicating acceptance of the pre-conditioning instructions by the user of the vehicle.

18. The system of claim 15, wherein the set of schedule information for the user of the vehicle comprises at least one of a set of calendar information collected by the cloud-based climate control service or information based on a learned routine of the user of the vehicle and maintained by the cloud-based climate control service.

19. The system of claim 15, wherein the set of information defining current conditions related to the vehicle comprises information received by the cloud-based climate control service from the vehicle and defining a current cabin temperature, a current ambient temperature, and a location of the vehicle.

20. The system of claim 15, wherein the set of information defining current conditions related to the vehicle comprises at least one of information collected by the cloud-based climate control service from a third-party weather reporting service and defining weather conditions at a location of the vehicle or information collected by the cloud-based climate control service from a third-party traffic reporting service and defining traffic conditions along an expected route of the vehicle based on the set of scheduling information for the user of the vehicle.
